(19) United States
(12) Patent Application Publication
(10) Pub. No.: US 2003/0217028 A1
(43) Pub. Date: Nov. 20, 2003

(54) Readers' information matrix (RIM)

(76) Inventor: Liza Ellen Gilbert, La Crosse, WI (US)

Correspondence Address: LIZA ELLEN GILBERT, 116 SOUTH 20th STREET, LA CROSSE, WI, 54601, US

(21) Appl. No.: 10/145,990

(22) Filed: May 14, 2002

(51) Int. Cl. G06F 7/00

(52) U.S. Cl. 707/1

(57) ABSTRACT

This is an index methodology which results in a standardized, formatted, access tool for readers to explore the indexed written work relative to symbolism, literary devices and styles, and soft or fuzzy references employed.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This is an original invention in the fields of library science, information science, information architecture, and publishing. It is a method of indexing works of fiction and works of nonfiction which allows cross-referencing and computer data searches. Prior to this invention, indexing in library science was limited in scope to literal concepts in nonfiction works. The concept of indexing fiction has been discussed for decades, but prior to this invention, there has not been a methodology available to accomplish this. This invention will advance the reader services field by standardizing the data available from previously unindexed materials.

### BRIEF SUMMARY OF THE INVENTION

This invention is a methodology, form, and directions for creating an index for written works which includes literary and symbolic content in addition to historical and literal content. It includes standards for formatting and field descriptions.

### BRIEF DESCRIPTION OF THE SEVERAL VIEWS OF THE DRAWING

Not Applicable.

### DETAILED DESCRIPTION OF THE INVENTION

Readers' Information Matrix

What? A universal, international system of collocating information in fiction and non-fiction materials according to consistent rules, standards, and guidelines in order to provide the user/reader with greater access and understanding of said materials.

What? A book-specific information collection and presentation system comprised of two main parts: the Readers' Portal and the Readers' Foundation.

Who? The RIM as a universal standard for collecting and presenting information in individual fiction and non-fiction materials is created, revised, adapted, and arranged by the inventor of RIM, Liza Ellen Gilbert.

Who? The RIM as a book-specific system of collocating and presenting information is created, arranged, and formatted according to the universal RIM standards, by the matrician responsible for RIMing a book.

When? The RIM as a universal system is adapted, changed, and evolved when the inventor deems it necessary or useful to do so for the advancement of information access, information freedom and the betterment of the world of literature.

When? The RIM as a book-specific system is either created post-publication of the material in order that the next edition of the non-RIMed material can be published with a RIM, or the RIM is created pre-publication. In either case the deadlines, timelines, and date specific details are determined by any combination of the following individuals: the matrician, the author, the publisher, the distributor, or the editor.

How? See The Universal Gilbert's Readers' Information Matrix (RIM) Rules and Standards for Formatting and Usage.

Where? The universal RIM standards are published and copyrighted by Liza Ellen Gilbert. The RIMs specific to single, individual texts/books appear within the same bound, covers as the text itself.

Readers' Portal

Who? Each Reader's Portal is created by the matrician responsible for RIMing the text. The matrician is not expected to work with the author, the guidelines for formatting and presentation are specified by the universal RIMing system, and the publishers, authors, and editors cannot tamper with the process or the formatting with the exception of issues agreed upon before the matrician begins to RIM a work.

What? The Reader's Portal is composed of four main items: the Port, the Sub Port, the Basement Port, and the Flag. The Port is an entry term, word, phrase, concept, or symbol used in the text or important to the understanding of the text. The Sub Port and Basement Port are Ports of lesser importance that are hierarchically placed underneath the main Port. The Flags point the user/reader to the page/section of the text wherein the entry term, word, phrase, concept, or symbol (i.e. the Port) is found.

The Readers' Portal is standardized as a word-by-word alphabetical arrangement of the Ports where the Ports are followed by varying numbers of Flags and/or Sub Ports and Basement Ports when the need arises.

The Readers' Portal is intended as a method of arranging information about the book's symbolism, characters, events, relationships, themes, aboutness, and other matrixable material with Flags so that the reader/user can easily reference the instances in the text in which the abovementioned ideas/concepts occur.

The Readers' Portal is to be used as a textual, verbal, and numerical roadmap to the Readers' Foundation. Ports in the Portal that occur in the Foundation are formatted in such a manner that the user/reader knows upon glancing at the Portal that more information concerning that symbol, character, event, relationship, theme, aboutness, or other matrixable material can be found in the Foundation.

When? The Reader's Portal is created by the matrician either port-publication or pre-publication of the chosen material. There are no restrictions placed on when the Portal needs to be created in relation to the Foundation.

Where? The Readers' Portal is found at the end of the author's text and before the Readers' Foundation.

Readers' Foundation

Who? Each Foundation is created by the matrician working on a specific text. The RIMing of one book cannot be divided amongst individuals working independently of one another. It is essential to the quality of the RIM that the Portal and the Foundation are created by the same individual(s).

When? The Foundation is either created port-publication or pre-publication by the matrician. There are no restrictions or time constraints on when the Foundation is created in relation to the creation of the Portal.

What? The Readers' Foundation is an word-by-word alphabetical listing of all of the Ports in the Portal the matrician determines need to be included in the Foundation in order to better define, describe, and illustrate relationship, theme, aboutness, events, characters, and other matrixable material in the text as well as the text itself, as a whole.

The Foundation contains some or all of the following items: Port, Port Pronunciation, Port Field Label, Port Etymology, Alternate Spellings or Pronunciations of Port, a universal definition of the Port, a definition specific to the author's use of the Port or the other information that helps the reader/user gain better access and understanding to the text/novel, cross references to Ports or Port Definitions in other texts/books, how and where the Port is entered in the Readers' Portal, the Flags indicating where the Port can be found in the text/book itself, and references and cross references to related, parallel, or other related material either in the Readers' Portal or in the Foundation.

Where? The Readers' Foundation is found after the author's text and after the Readers' Portal.

Port

Who? Each Port is chosen by the matrician according to the universal RIM standards and guidelines.

When? The Ports are chosen by the matrician at the time of RIMing a work.

What? A Port is a term, idea, concept, symbol, phrase, or word that acts as a launching pad/starting place for the reader/user to embark on greater understanding of the Port, the broader terms, ideas, concepts, and symbolism, or the work itself.

Where? The Ports in a RIM appear in both the Readers' Portal and the Readers' Foundation. In both cases, the Ports are the items justified more to the left than any other item in the Portal and the Foundation.

Flag

Who? The Flags are predetermined by the publishing company since they are responsible for numbering the pages of the text. However, the insertion and use of Flags, or the deletion or exclusion of Flags is the sole responsibility of the matrician.

What? A Flag works as a location device which the user/reader uses in order to determine where in the text a certain Port can be found.

Who? Flags are determined and chosen by the matrician at the time of RIMing.

Where? The Flags appear after the Ports in the Readers' Portal; in the Readers' Foundation the Flags appear in references and cross references to related and parallel materials as well as after the definition of any or all Ports mentioned within the text of the definition.

Main Port

What? A Main Port is a Port that occupies the highest of three hierarchical positions in the Portal.

Who? The matrician determines what the Port is.

When? The Main Ports are chosen/determined at the time of RIMing.

Where? The Main Port is the item most justified to the left in the Readers' Portal. In the Readers' Foundation, the Main Port can either be a Port, or act as a Flag to a Sub Port or a Basement Port in references and cross references to related or parallel materials.

Sub Port

What? A Sub Port is matrixable material that is hierarchically related on a lower level to the Main Port.

Who?The matrician determines what the Sub Ports are.

When? The Sub Ports are chosen/determined at the time of RIMing.

Where? The Sub Ports are indented underneath the Main Ports in the Reader's Portal. A Sub Port can act as a Main Port in the Readers' Foundation, or it can act as a Flag for a Basement Port in the Foundation in the case of references or cross references to related or parallel materials.

Basement Port

What? A Basement Port is the lowest of Ports on a hierarchical scale. All Basement Ports would contain/refer to the most specific information concerning what the Port represents, whereas the Main Port would be the broadest.

Who? The matrician determines what the Basement Ports are.

When? The Basement Ports are chosen/determined at the time of RIMing.

Where? In the Readers' Portal, the Basement Port is indented underneath the Sub Port. In the Readers' Foundation a Basement Port can act as a Main Port or a Flag for related and or parallel material.

Port Pronunciation

What? The Port Pronunciation indicates the correct manner in which the words used in the Port should be articulated when spoken and how the words should sound when heard.

Who? The Port Pronunciation is done by the matrician who should be trained in the universal RIM standard procedures for illustrating pronunciations. In the case of language used in a Port with which the matrician is not familiar, it is the responsibility of the matrician to research the language and related Port material in order to find or develop the correct Port Pronunciation.

When? The Port Pronunciation is done by the matrician as soon as the matrician has decided that that specific Port will be included in the Readers' Foundation.

Where? The Port Pronunciation is found in the Readers' Foundation immediately after the Port itself.

Port Field Label

What? The Port Field Label indicates the -ology or field from which the language used to describe the Port originates.

Who? A list of Port Field Labels are established in the rules and guidelines of the universal RIM, but the matrician is responsible for knowing the Port well enough to determine which Port Field Label needs to be applied to what Port.

When? A Port Field Label can be applied to a Port as soon as the matrician has determined that that specific Port will be used in the Readers' Foundation.

Where? The Port Field Label appears in the Readers' Foundation directly after the Port Pronunciation, which follows the Port itself.

Port Etymology

What? The Port Etymology is an abbreviation indicating the etymology of the language used to describe or be the port.

Who? A list of acceptable etymological abbreviations is created and provided by the inventor of the universal RIM, Liza Ellen Gilbert. It is expected that all abbreviations be consistent throughout texts regardless of the identity of the matrician. However, the matrician is responsible for knowing the material and the Port well enough to determine under which etymological abbreviation the Port is placed, and it is the matrician's responsibility to choose the correct or best-fitting etymological abbreviation.

When? The Port Etymology can be included and completed as soon as the matrician has determined that that specific Port will be included in the Readers' Foundation.

Where? The Port Etymology appears in the Readers' Foundation directly after the Port Field Label.

Port Word Form

What? The Port Word Form is an abbreviation that indicates the type of word(s) of which the Port is composed.

Who? The matrician is responsible for determining the Port's Word Form as well as adhering to the approved abbreviations for Port Word Forms which are devised, edited, and updated by the inventor, Liza Ellen Gilbert.

When? The matrician can determine and include the Port Word Form as soon as he/she has decided that that Port will be included in the Readers' Foundation.

Where? The Port Word Form appears in the Readers' Foundation directly after the Port Etymology.

Alternate Spellings & Pronunciations of Port

What? The Alternate Spellings and Pronunciations of the Port as a section is comprised of the language used by the author of the text, by other authors, or as the preferred general usage in order to describe that specific Port.

Who? The matrician is responsible for identifying alternate spellings and pronunciations and determining whether or not it is necessary or of sufficient use to include the variants in the RIM.

When? The Alternate Spellings & Pronunciations of Port can be included and completed as soon as the matrician has determined that that specific Port will be included in the Readers' Foundation.

Where? The Alternate Spellings & Pronunciations of Port appear in the Readers' Foundation after the Port Word Form.

Universal Port Definition

What? The Universal Port Definition is a definition of the language used to describe the Port as it is understood by the general public, or, in the case of rare, esoteric, or antiquated terms, it is the definition most accepted by experts in the field under which the Port falls.

Who? The matrician is responsible for completing sufficient research to succinctly word a Universal Port Definition for each Port present in the Readers' Foundation.

When? The Universal Port Definition can be included and written by the matrician as soon as said matrician has decided that that Port will be included in the Readers' Foundation.

Where? The Universal Port Definition is located in the Readers' Foundation immediately following the Alternate Spellings & Pronunciations of Port.

Book-Specific Port Definition

What? The Book-Specific Port Definition is added and tailored information provided for the reader/user to better understand how the author/text uses the Port in the book.

Who? The matrician is responsible for identifying and wording the Book-Specific Port Defintion.

When? As soon as the matrician has determined that a specific Port will be included in the Readers' Foundation, the Book-Specific Port Definition can be developed/included.

Where? The Book-Specific Port Definition in located within the Reader's Foundation and falls immediately after the Universal Port Definition.

Inter-Matrix References

What? Inter-Matrix References are statements made to indicate that more, similar, or parallel information about a specific Port can be found in the RIM of another text/book.

Who? The matrician of the primary text is responsible for researching and identifying similar and parallel information that has been RIMed in other materials. The matrician is also responsible for determining whether or not the RIMed material is of sufficient relevance to be included. The matrician of the book being referenced, whether it is the same matrician or not, is responsible for the material in that book's RIM.

When? The matrician can develop/identify/include Inter-Matrix References as soon as the matrician has determined that that specific Port will be included in the Readers' Foundation.

Where? The Inter-Matrix References are located in the Readers' Foundation, and they are the final materials listed in a Port's entry.

Readers' Foundation's Port's Portal Entry

What? The Readers' Foundation's Port's Portal Entry is the Port, Sub Port, or Basement Port under which the Port in the Readers' Foundation can be found in the Readers' Portal.

Who? The matrician is responsible for identifying and illustrating the Readers' Foundation's Port's Portal Entry.

When? The matrician can include and define the Readers' Foundation's Port's Portal Entry as soon as the matrician has completed enough of the Readers' Portal to be able to identify the location of the Port in the Readers' Portal.

Where? The Readers' Foundation's Port's Portal Entry is located in the Readers' Foundation directly after the definition(s) of the Port.

Intra-RIM References & Cross References

What? An Intra-RIM Reference or Cross Reference indicates to the user/reader that there is extra, related, useful, or parallel material located elsewhere within the same text's RIM.

Who? The Intra-RIM References and Cross References are the responsibility of the matrician.

When? The matrician should not begin work on the Intra-RIM References & Cross References until after the entire rest of the text's RIM is completed.

Where? The Intra-RIM References and Cross References are located in the Readers' Foundation in relation to the location of item(s) being referenced or cross referenced, according to the universal rules and guidelines of RIM formatting.

Foundation Flags

What? Foundation Flags are Flags directing the user/reader to specific locations within the text where specific Ports can be located.

Who? The matrician is responsible for identifying and illustrating the Foundation Flags.

When? The matrician should begin identifying and illustrating Foundation Flags as soon as said matrician has determined that that specific Port will be included in the Readers' Foundation; however, the matrician should also not complete work on the insertion of Foundation Flags until after all of the Intra-RIM References and Cross References have been identified, as each of the Intra-RIM References and Cross References may need to have Foundation Flags attached to them.

Where? Foundation Flags appear in the Readers' Foundation in relation to the location of the Port according to the universal rules and guidelines for RIM formatting.

Decoding Depot

What? The Decoding Depot is a set of words, phrases, sentences, paragraphs, or pages that provide the reader/user with information essential in order to fully understand the text and in order to adhere to the concept of equitable access to fictional and non-fictional material regardless of educational level. The Decoding Depot is the place in which the matrician provides the user/reader with information about cultural, historical, linguistic, artistic, musical, technical, and other specialized material so that each reader/user is brought closer to an equal level of comprehension and equal knowledge bases specific to that text.

Who? The matrician is responsible for identifying material that needs to be included in the Decoding Depot. The matrician is also responsible for completing the research necessary to write the material to be included in the Decoding Depot.

When? The matrician, if she/he reads the text prior to commencing RIMing, can begin writing the information to be included in the Decoding Depot as soon as he/she has finished reading the text. If the matrician RIMs while reading the text, the matrician should not begin drafting information to be included in the Decoding Depot until after the matrician has completed RIMing the entire work.

Where? The Decoding Depot as a location is the space at the top of the Reader's Foundation, situated before and above any of the Ports.

Matricians' Note of Respect

What? The Matricians' Note of Respect is the act of giving the matrician due credit for RIMing a text by publishing the name of the matrician, in the nomenclatural form she/he wishes it to appear, in the same volume or text as that in which the RIM appears.

The Matricians' Note of Respect is the actual location in which the matrician is given due credit for RIMing a text.

Who? The matrician is responsible for letting the publisher, editor, or other parties responsible for formatting the volume as a whole how she/he wishes her/his name to appear.

The publisher is responsible for ensuring that each text published with a RIM includes a Matricians' Note of Respect. No RIM may be published without a Matricians' Note of Respect without violating the standards of this patent described in these pages.

When? The Matrician's Note of Respect must appear in the first edition and all subsequent editions of a volume that includes a matrician's original RIM.

Where? The publisher may determine whether the Matricians' Note of Respect will appear with other copyright information at the front of the volume or within the RIM itself.

The Universal Gilbert's Readers' Information Matrix (RIM) Rules and Standards for Formatting and Usage

The inclusion of this text in the description for the patent is necessary since this text provides all of the information pertaining to the procedure of creating a RIM, RIMing a book, and the standards necessary for the continuity and consistency of this process over time and throughout materials.

Formatting a Readers' Portal

Every Readers' Portal is formatted so that all Ports appear in word-by-word alphabetical order. Letter-by-letter alphabetical order is not acceptable.

Every Readers' Portal must have two columns (unless there is insufficient information to form more than one column).

All Ports are formatted in lower case letters except for proper nouns which are to be capitalized.

All Ports comprised of proper nouns are to be arranged according to the manner in which the bulk of the material refers to said proper noun. Example: if a character's name is John Bean but in the majority of the work the character is referred to as Bean, the Port for the character's name “John Bean” would be “Bean, John”.

All Ports comprised of proper nouns in which an inversion or reversal has taken place (as described above) to improve access, references and/or cross references must be added when the matrician deems it necessary, to call the reader/user's attention to other variations. Example: the Port for “John Bean” has been established as “Bean, John.” However, if the matrician deems it useful or necessary, the Reader's Portal must include the port “John Bean. See Bean, John.” in order that the reader/user can be directed to the Port providing the actual information about said character.

All Ports comprised of works that, in non-RIM compositions would be italicized or underlined are to be underlined, without exception. This rule is set forth as thus for reader/user accessibility. Because references and cross references are italicized, works must be underlined to avoid confusion.

All references and cross references must be italicized. Examples: See; See also; See also in portal.

The first word in every reference and cross reference must be capitalized.

All Ports are to be spelled according to the manner in which they appear most frequently in the text. In the cases of misspellings and spelling variations, the matrician is responsible for determining whether references or cross references are useful or needed for the reader/user.

No more than five Flags may appear after each Port, Sub Port, or Basement Port.

All Flags are separated from each other and from the Port to which they are assigned by commas. Example: “Bean, John, 5, 14, 34”

All Ports, Sub Ports, and Basement Ports must be formatted in an indented style. No Readers' Portal may be formatted in the run-in style. This rule is set forth here for the benefit of accessibility to the reader/user of the RIM.

There are to be no limit to the number of Sub Ports or Basement Ports under any given Main Port or Sub Port. However, hierarchically there are to be no Ports lower than a Basement Port.

When a series of Sub Ports and/or Basement Ports continues in another column or on another page, the matrician is responsible for notifying the user/reader of the Main Port or Sub Port under which the series falls. Example: if a column extends to another column or another page, the matrician is responsible for including text such as the following—“Bean, John (continued)” before inserting the remainder of the series of Sub Ports or Basement Ports.

All Sub Ports must be indented no less than three spaces from the left justification of the Main Ports.

All Basement Ports must be indented no less than three spaces from the left justification of the Sub Port under which the Basement Port falls.

Each Port, Sub Port, or Basement Port in the Readers' Portal that has an entry or is represented in the Readers' Foundation is to be formatted in boldface.

Any term, word, or phrase deemed important or necessary by the matrician can be made a Port even if the Port would only have one Flag and even if the Port would have no Sub Ports or Basement Ports. However, the matrician can only matrix Ports with these qualities if the usage of them in the text by the author is important or considered matrixable material. The matrician may not randomly or needlessly matrix Ports with these qualities unless they have such added value.

If part of a proper noun's linguistic material is not mentioned enough times to be deemed matrixable by the matrician, the matrician is thereby not required to include references or cross references to other or all variations, nor is the matrician required to include all of the proper noun's linguistic material in the Port under which the matrician does decide to matrix the material. Example: if a feature in a novel is “The Cat Scratch River” but the author refers to it as “The Cat Scratch River” very few times, preferring to use a variation such as “The Cat River” or “Cat River,” the matrician has every right to matrix “The Cat Scratch River” under “The Cat River” or “Cat River” without including references or cross references to the proper noun's full linguistic material, “The Cat Scratch River.” If the matrician feels that the reader/user can benefit from knowing the proper noun's full linguistic material but does not wish to matrix the Port as such, the matrician may include the full linguistic material in the Readers' Foundation, making sure that the Port in the Readers' Portal is then formatted in boldface.

All Flags are to be formatted according to the manner in which the text is paginated. If the text uses Roman Numerals, letters of the alphabet, section numbers, or any other system, the Flags used by the matrician must reflect the pagination system of the text.

The Readers' Portal always precedes the Readers' Foundation in the sequence of a volume; the Readers' Portal always follows the all the author's material.

Formatting a Readers' Foundation

The Readers' Foundation is arranged alphabetically word-by-word according to each Port, not letter-by-letter.

All Ports comprised of works that, in non-RIM compositions would be italicized or underlined are to be underlined, without exception. This rule is set forth as thus for reader/user accessibility. Because references and cross references are italicized, works must be underlined to avoid confusion.

All Ports in the Readers' Foundation are left justified to the same degree: there is no hierarchy of Ports in the Readers' Foundation. If a Port that appears in the Readers' Foundation is a Sub Port or a Basement Port in the Readers' Portal, the Port is still left justified to the same degree as Ports that were Main Ports in the Readers' Portal.

All Ports appearing as main entries in the Readers' Foundation are to be formatted in boldface with all capital letters with some linguistic exceptions. For example: in a Port in the Readers' Portal appears as “Mississippi River,” in the Readers' Foundation it appears as “MISSISSIPPI RIVER.” However, if a Port in the Readers' Portal appears as “DeGeneres, Ellen,” it appears in the Readers' Foundation as “DeGENERES, ELLEN”.

Any words, terms, or phrases in a Port's definition that, in and of themselves are Ports in the Readers' Foundation must be formatted in boldface. Example: if the definition for the Port “BLOOD” is “red, gooey liquid” and the words “red” and “liquid” are also Ports, then the definitions needs to be formatted as “red, gooey liquid”.

Ports in the Readers' Foundation must appear in the same form that they appear in the Readers' Portal. Example: if the Port in the Readers' Foundation is “homicidal maniac,” the Port in the Readers' Foundation must read “HOMICIDAL MANIAC.” However, if the Port in the Readers' Foundation appears as “Gein, Ed,” the Port in the Reader's Foundation must appear as “GEIN, ED.” Word order must be maintained throughout the RIM as a whole.

Port Pronunciation must be configured according to the most recent edition of the International Phonetic Alphabet available at the time of RIMing.

Stresses and syllables must be identified in Port Pronunciations according to the International Phonetic Alphabet (IPA).

Not all Port entries in the Readers' Foundation are required to have all of the items that a matrician has at her/his disposal.

Illustrated & Explained Example of a Port Entry in a Readers' Foundation

BLOOD (bl [symbol] d) Anatom. Eng. n. red, gooey liquid [anatomy: blood, 35, 67, 142] See also hemoglobin [anatomy: blood: hemoglobin, 24, 45, 93, 102] See also in Portal vampires. Other ‘Salem's Lot by Stephen King: vampires: feeding behavior.

BLOOD=Port

(bl [symbol] d)=Port Pronunciation in IPA

Anatom.=Field Label indicating that this Port is in the field of “anatomical” terms

Eng.=Port Etymology indicating that the term is English

n.=Port Word Form Abbreviation indicating that “BLOOD” is a noun

red, gooey liquid=book-specific definition. The fact that “red” and “liquid” are in boldface indicates that this Readers' Foundation includes “red” and “liquid” as Ports unto themselves.

[anatomy: blood, 35, 67, 142]=The Readers' Foundation's Port's Portal Entry where “anatomy” is the Main Port in the Readers' Portal for the Sub Port “blood” and the number sequence “35, 67, 142” is a series of Flags indicating the location within the author's text where the term “blood” can be found.

See also hemoglobin=Intra-RIM Port Reference, whereas, since “hemoglobin” is in boldface the reader/user knows that “hemoglobin” is a Port in the Readers' Foundation.

[anatomy: blood: hemoglobin, 24, 45, 93, 102]=The Readers' Foundation's Port's Portal Entry where “anatomy” is the Main Port, “blood” is the Sub Port, and “hemoglobin” is the Basement Port. The sequence of numbers “24, 45, 93, 102” is a series of Flags indicating the location within the author's text where the term “hemoglobin” can be found.

See also in Portal vampires=Intra-RIM Port Reference indicating that there is parallel or related material on the Port “BLOOD” in the Readers' Portal under the Main Port “vampires.” The fact that the word “vampires” is not in bold indicates that there is not a Port Entry in the Readers' Foundation for this term.

Other ‘Salem's Lot by Stephen King: vampires: feeding behavior=Intra-RIM Reference where “Other” indicates that this is an Intra-RIM Reference, ‘Salem's Lot is the text being referenced, “by Stephen King” is essential author information necessary in order to distinguish works with similar or identical titles from one another, “vampires: feeding behavior” is the Readers' Foundation's Port's Portal Entry for additional or parallel information about “BLOOD” in ‘Salem's Lot; where “vampires” is a Main Port in the Readers' Portal of the RIM for ‘Salem's Lot, “feeding behavior” is the Sub Port in the Readers' Portal of the RIM for ‘Salem's Lot, and “feeding” in boldface is the indicator that the term “feeding” is a Port in the Readers' Foundation of the RIM for ‘Salem's Lot.

Illustrated & Explained Example of a Reader's Portal

| | |
|---|---|
| astronomy, 2, 4 | evolution, 105, 107, 109-39 |
| astrophysics, 14, 17, 23 | religious views of, 110, 112-20 |
| baseball | Darwinism, 135-39 |
| baseballs, 47, 93-102 | Darwin, Charles, 135, 137, 139 |
| autographed baseballs, 98 | floozy, 204, 235, 310 |
| Bob the Builder, 17, 19, 43 | jazz, 200, 201, 203 |
| Bob the Builder, 17 | kangaroo, 400, 489, 625, 657 |
| cretins, 2-5 | lemur, 315, 378, 380 |
| devastation, 34-40 | mountains, 721 |
| hurricane, 34-36 | Rocky Mountains, 724, 726-80 |
| tornadic, 36-40 | in Canada, 760, 764, 777-79 |

All of the information from the “a” in “astronomy” to the last “9” at the bottom of the right column is of what the Readers' Portal is composed.

“astronomy,” “astrophysics,” “baseball,” “Bob the Builder,” “cretins,” “devastation,” “evolution,” “floozy,” “jazz,” “kangaroo,” “lemur,” and “mountains” are all Main Ports.

Under “baseball,” “baseballs” is the Sub Port and “autographed baseballs” is the Basement Port.

The Main Entry “Bob the Builder” refers to the character, Bob the Builder, while “Bob the Builder,” the Sub Port of “Bob the Builder,” refers to a work by the same name.

“religious views of” and “Darwinism” are both Sub Ports of the Main Port “evolution,” while “Darwin, Charles” is a Basement Port of only “Darwinism”.

The Main Port “jazz,” the Sub Ports “baseballs,” and “tornadic,” and the Basement Ports “Darwin, Charles,” and “in Canada” all indicate that there are Ports in the Readers' Foundation for these terms along with additional and tailored information about these concepts.

Acceptable Port Abbreviations

| | |
|---|---|
| abbrev. | abbreviation |
| adj. | adjective |
| adv. | adverb |
| Afr. | African |
| Am.In. | Indigenous American |
| Am. | American |
| anatom. | anatomical |
| Ar. | Arabic |
| arch. | architectural |
| archaeo. | archaeological |
| arith. | of or relating to arithmetic or mathematics |
| AS | Anglo-Saxon |
| astrol. | astrological |
| astron. | astronomical |
| bio. | biological |
| botan. | botanical |
| Braz. | Brazilian |
| Brit. | British |
| Canad. | Canadian |
| Celt. | Celtic |
| Chi. | Chinese |
| colloq. | colloquial |
| comp. | of or relating to computers or computational work |
| comp.tech. | computer technological |
| conj. | conjunction |
| Corn. | Cornish |
| Dan. | Danish |
| Dut. | Dutch |
| Egypt. | Egyptian |
| Eng. | English |
| Esk. | Eskimo |
| eth. | ethnological |
| Eur. | European |
| Fin. | Finnish |
| Flem. | Flemish |
| Fr. | French |
| Gae. | Gaelic |
| geog. | geographical |
| Ger. | German |
| Gr. | Greek |
| Haii | Hawaiian |
| Heb. | Hebrew |
| Hin. | Hindi |
| hist. | historical |
| hort. | horticultural |
| Hungr. | Hungarian |
| Ice. | Icelandic |
| Ind. | of India or the people of India |
| Indo-Eur. | Indo-European |
| interj. | interjection |
| Intrnt. | of or relating to the Internet |
| Irsh | Irish |
| Ital. | Italian |
| Japn. | Japanese |
| Lat. | Latin |
| latn. | Latino |
| lis. | library/information studies/science |
| M.E. | Middle English |
| math. | anything relating to mathematics |
| mech. | mechanical |
| med. | medieval |
| medc. | medical |
| Mex. | Mexican |
| milit. | military |
| min. | mineralogical |
| myth. | mythological |
| n. | noun |
| N.A. | North American |
| Nor. | Norse |
| Norm. | Norman |
| Norwg. | Norwegian |
| O.E. | Old English |
| ornit. | ornithological |
| p. | participle |
| para. | Paranormal |
| Pers. | Persian |
| Peru. | Peruvian |
| pharm. | pharmacological |
| Phil. | Philippine |
| philol. | philological |
| philos. | philosophical |
| Phoen. | Phoenician |
| phys. | physiological |
| Pol. | Polish |
| Portg. | Portuguese |
| prep. | preposition |
| pron. | pronoun |
| psyc. | psychological |
| Rom. | Roman |
| Rus. | Russian |
| S.A. | South American |
| S.Af. | South African |
| San. | Sanskrit |
| Scandv. | Scandinavian |
| Scot. | Scotch |
| Sem. | Semitic |
| Serb. | Serbian |
| slang. | slang. |
| Slav. | Slavic |
| Sp.Am. | Spanish American |
| Span. | Spanish |
| Swed. | Swedish |
| Syr. | Syrian |
| Tag. | Tagalog |
| tech. | technological |
| Teut. | Teutonic |
| theol. | theological |
| Turk. | Turkish |
| v. | verb |
| web. | of or relating to the World Wide Web |
| Welsh. | Welsh |
| Yid. | Yiddish |
| zool. | Zoological |

Matricians have a discretionary right to use their own abbreviations for terms or concepts whose abbreviations are NOT listed in the above list.

1. I claim as my invention the two part index of a written work which includes non-literal, literary, symbolic, and “fuzzy” entries in the format specified in the description section of this patent application.
